(19) United States
(12) Patent Application Publication
(10) Pub. No.: US 2026/0318407 A1
(43) Pub. Date: Oct. 15, 2026

(54) VEHICLE CONTROL DEVICE

(71) Applicant: TOYOTA JIDOSHA KABUSHIKI KAISHA, Toyota-shi (JP)

(72) Inventor: Katsuya SASAKI, Nagoya-shi (JP)

(73) Assignee: TOYOTA JIDOSHA KABUSHIKI KAISHA, Toyota-shi (JP)

(21) Appl. No.: 19/530,660

(22) Filed: Feb. 5, 2026

(30) Foreign Application Priority Data
Apr. 14, 2025 (JP) 2025-066330

(51) Int. Cl. F16H 61/4192

(52) U.S. Cl. CPC F16H 61/4192

(57) ABSTRACT

The control device calculates a predicted value of the transmission torque that can be transmitted by the power transmission device based on the stop time from the time when the oil pump is stopped to the time when the oil pump starts driving for the first time after the oil pump is stopped, and the time-series data of the rotational speed of the oil pump after the oil pump starts driving. The control device determines whether or not a lost drive state of the power transmission device has occurred based on the calculated predicted value of the transmission torque.

### CROSS-REFERENCE TO RELATED APPLICATION

This application claims priority to Japanese Patent Application No. 2025-066330 filed on Apr. 14, 2025. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

Japanese Unexamined Patent Application Publication No. 2019-219053 (JP 2019-219053 A) describes a vehicle control device for a vehicle including a power transmission device provided between an engine and a transmission mechanism. The power transmission device transmits power from a pump impeller connected to a crankshaft of the engine to a turbine impeller connected to a transmission mechanism via oil.

The control device determines whether a lost drive state of the power transmission device has occurred based on the amount of increase in the rotational speed of the engine a predetermined time after the time when the engine is started.

### SUMMARY

In the vehicle control device described in JP 2019-219053 A, there is room for improvement in order to improve the accuracy of determination as to whether a lost drive state has occurred.

In order to address the above issue, an aspect provides a vehicle control device that controls a vehicle including:
a power transmission device that is provided between an engine and a transmission mechanism and transmits power from a pump impeller connected to a crankshaft of the engine to a turbine impeller connected to the transmission mechanism via oil; and an oil pump that supplies the oil to the power transmission device, in which
the vehicle control device
calculates a predicted value of a transmission torque transmitted to the transmission mechanism by the power transmission device based on a stop time since a time when the oil pump is stopped until a time when the oil pump starts driving for a first time after being stopped, and time-series data of a rotational speed of the oil pump from a time when the oil pump starts driving, and
determines based on the predicted value calculated whether a lost drive state of the power transmission device has occurred.

By determining whether the lost drive state has occurred using the predicted value of the transmission torque calculated based on the stop time, the control device can improve the accuracy of determining whether the lost drive state has occurred as compared with the case where the determination is made based on only the time-series data of the rotational speed of the oil pump.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of one embodiment of a vehicle; and

FIG. 2 is a flowchart illustrating a series of processes including determination of whether or not a lost drive state has occurred, which is performed by the control device of FIG. 1.

### DETAILED DESCRIPTION OF EMBODIMENTS

### One embodiment

### Outline of the vehicle

Hereinafter, an embodiment of a vehicle control device will be described with reference to the drawings.

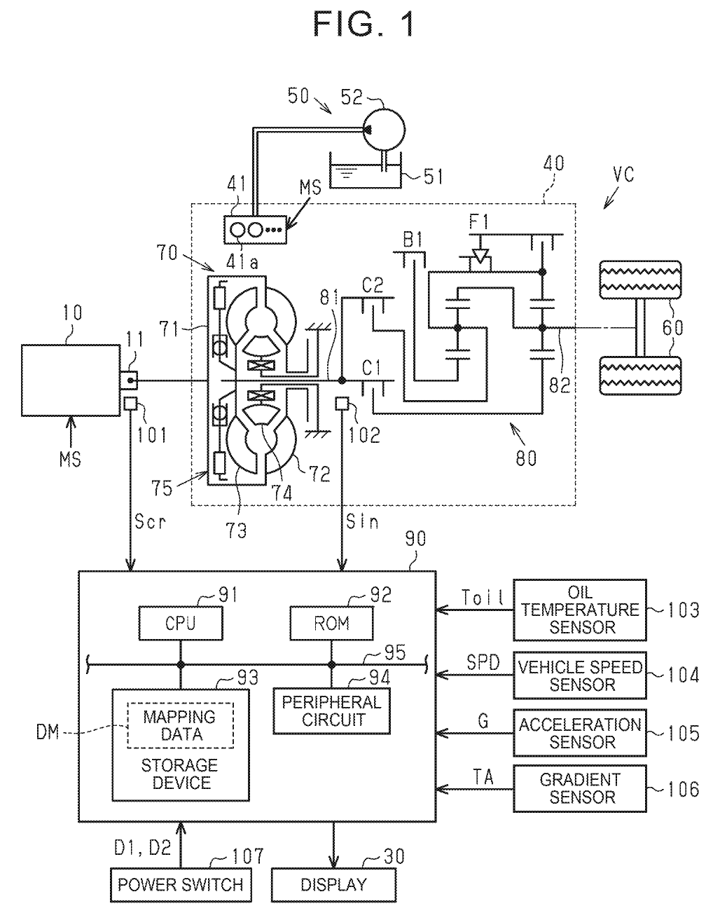

As illustrated in FIG. 1, the vehicle VC includes an engine 10, a transmission device 40, an oil supply mechanism 50, and a plurality of drive wheels 60.

The transmission device 40 includes a torque converter 70 and a transmission mechanism 80. The torque converter 70 is connected to the crankshaft 11 of the engine 10. The input shaft 81 of the transmission mechanism 80 is connected to the torque converter 70. That is, the torque converter 70 is connected between the engine 10 and the transmission mechanism 80. The torque converter 70 is a power transmission device. The drive wheel 60 is coupled to the output shaft 82 of the transmission mechanism 80 via a differential (not shown).

The torque converter 70 includes a front cover 71, a pump impeller 72, a turbine impeller 73, and a stator 74. The front cover 71 is connected to the crankshaft 11 of the engine 10. The pump impeller 72 rotates integrally with the front cover 71. The turbine impeller 73 rotates integrally with the input shaft 81 of the transmission device 40. The stator 74 has a function of amplifying torque between the pump impeller 72 and the turbine impeller 73.

When the pump impeller 72 is rotating based on the engine operation, the rotation of the pump impeller 72 is transmitted to the turbine impeller 73 via the oil in the torque converter 70, so that the output torque of the engine 10 is input to the transmission mechanism 80. That is, the torque converter 70 transmits power from the pump impeller 72 connected to the crankshaft 11 to the turbine impeller 73 connected to the transmission mechanism 80 via the oil.

The torque converter 70 includes a lock-up clutch 75. When the lock-up clutch 75 is in the engaged state, the pump impeller 72 and the turbine impeller 73 are mechanically connected via the lock-up clutch 75. Therefore, when the lock-up clutch 75 is in the engaged state, the output torque of the engine 10 is transmitted from the front cover 71 to the turbine impeller 73 via the lock-up clutch 75, and is input to the transmission mechanism 80.

The transmission mechanism 80 includes a first clutch C1, a second clutch C2, a brake mechanism B1, and a one-way clutch F1. The shift stage of the transmission device 40 is switched by the combination of the engaged state and the disengaged state of the

first clutch C1, the second clutch C2, and the brake mechanism B1, and the combination of the restricted state and the allowable state of the one-way clutch F1.

The vehicle VC includes an oil supply mechanism 50. The oil supply mechanism 50 supplies oil to the transmission device 40. The oil supply mechanism 50 includes an oil pan 51 for storing oil and a mechanically driven oil pump 52. The driven shaft of the oil pump 52 is connected to the pump impeller 72, although not shown. The oil pump 52 is driven by rotation of the pump impeller 72. That is, the oil pump 52 is driven when the pump impeller 72 rotates as the crankshaft 11 rotates. Therefore, the oil pump 52 starts driving when the engine 10 is started. The oil pump 52 stops driving when the engine 10 stops.

The oil pump 52 sucks the oil in the oil pan 51 and discharges the oil to the transmission device 40. The pressure of the oil discharged from the oil pump 52 is adjusted by a hydraulic control circuit 41 of the transmission device 40. The hydraulic control circuit 41 includes a plurality of solenoid valves 41a. The hydraulic control circuit 41 controls the oil flow state and the oil pressure by energizing each solenoid valve 41a.

The vehicle VC comprises a display 30. The display 30 is, for example, a meter display. The display 30 is provided in the vicinity of the driver's seat of the vehicle VC. The display 30 is capable of displaying images showing various types of information.

The control device 90 operates various operating units of the engine 10 by outputting various control signal MS so as to control the torque/exhaust component ratio and the like, which are control amounts of the engine 10. Further, the control device 90 controls the transmission device 40 and operates the solenoid valve 41a of the hydraulic control circuit 41 by outputting various control signal MS.

The control device 90 refers to the output signal Scr of the crank angle sensor 101 when controlling the control variable. The control device 90 refers to the output signal Sin of the input shaft rotation angle sensor 102 that detects the rotation angle of the input shaft 81 of the transmission device 40.

The control device 90 refers to an oil temperature detection value Toil which is a temperature of oil detected by the oil temperature sensor 103. The control device 90 refers to the vehicle speed SPD which is the moving speed of the vehicle VC detected by the vehicle speed sensor 104.

The control device 90 refers to the vehicle acceleration G, which is the acceleration of the vehicle VC detected by the acceleration sensor 105. The control device 90 detects the tilt angle TA of the front-rear shaft of the vehicle VC with respect to the horizontal plane detected by the gradient sensor 106. Specifically, the gradient sensor 106 detects an upward gradient angle and a downward gradient angle. For example, the gradient sensor 106 detects an upward gradient angle as a positive tilt angle TA. The gradient sensor 106 detects a downward gradient angle as a negative tilt angle TA.

The control device 90 ascertains an activation request D1 or a stop request D2 of the vehicle VC system on the basis of an input signal from the power switch 107. The activation request D1 of the vehicle VC is a request for starting the engine 10. The stop request D2 of the vehicle VC is a request for stopping the engine 10.

The control device 90 includes a CPU 91 which is a processing circuit, a ROM 92, a storage device 93 which is an electrically rewritable nonvolatile memory, and a peripheral circuit 94. CPU 91, ROM 92, the storage device 93, and the peripheral circuit 94 can communicate with each other via an internal bus 95.

The peripheral circuit 94 includes a circuit for generating a clock signal defining an internal operation, a power supply circuit, a reset circuit, and the like. The control device 90 controls various control amounts by CPU 91 executing a program stored in ROM 92.

The storage device 93 stores a mapping data DM. The mapping data DM is data defining a mapping for outputting an output variable corresponding to the input variable when various input variables to be described later are input, and includes data learned by machine learning.

CPU 91 calculates the rotational speed of the oil pump 52 based on Scr detected by the crank angle sensor 101. CPU 91 stores the calculated rotational speed of the oil pump 52 in the storage device 93 in association with the time.

CPU 91 starts the engine 10 when CPU 91 acquires the activation request D1 from the power switch 107. When the engine 10 is started, the driven shaft of the oil pump 52 rotates as the crankshaft 11 rotates, so that the oil pump 52 starts driving.

CPU 91 deactivates the engine 10 when CPU 91 obtains the stop request D2 from the power switch 107. When the engine 10 stops, the rotation of the driven shaft of the

oil pump 52 stops as the rotation of the crankshaft 11 stops, and thus the oil pump 52 starts stopping.

When CPU 91 acquires the stop request D2 from the power switch 107, CPU 91 stores the oil temperature detection value Toil at the time when the stop request D2 is acquired in the storage device 93 as the stop time temperature T1 which is the temperature of the oil at the time of the stop. When CPU 91 acquires the stop request D2 from the power switch 107, CPU 91 starts a timer for measuring the stop time ST of the oil pump 52. The stop time ST is a time from the time when the oil pump 52 is stopped to the time when the oil pump 52 starts driving for the first time after the oil pump is stopped.

### A series of processing related to determination of the lost drive state

When CPU 91 acquires the activation request D1 from the power switch 107, it starts a series of processes including determining whether or not a lost drive status of the torque converter 70 has occurred. The lost drive state is a state in which the transmission torque is lowered to such an extent that the vehicle VC cannot be started due to insufficient oil in the torque converter 70.

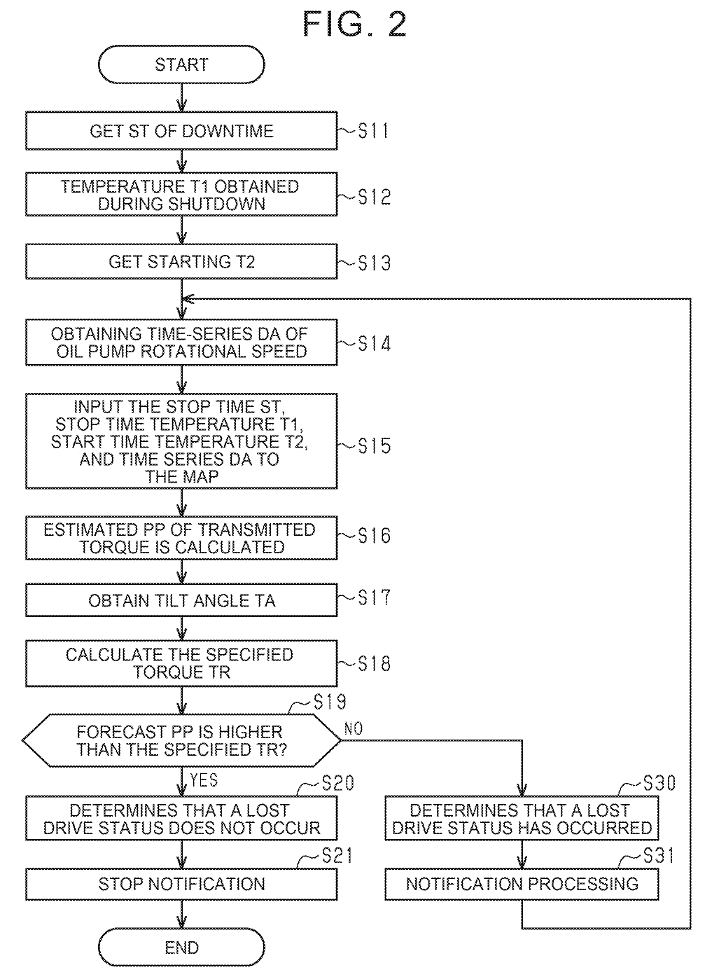

As illustrated in FIG. 2, CPU 91 first performs a S11 process when the activation request D1 is acquired from the power switch 107. In S11, CPU 91 obtains a stop time ST. Specifically, CPU 91 stops the timer that has measured the stop time ST. Thus, CPU 91 acquires the measurement time of the timer as the stop time ST. Thereafter, CPU 91 advances the process to S12.

In S12, CPU 91 acquires the stop time temperature T1 stored in the storage device 93. Thereafter, CPU 91 advances the process to S13.

In S13, CPU 91 acquires the oil temperature detection value Toil at the time of acquiring the activation request D1 as the start time temperature T2 which is the temperature of the oil at the start time. Thereafter, CPU 91 advances the process to S14.

In S14, CPU 91 acquires the time-series data DA of the rotational speed of the oil pump 52 after acquiring the activation request D1. Specifically, CPU 91 acquires time-series data of the rotational speed of the oil pump 52 from the time when the activation request D1 is acquired to the most recent time stored in the storage device 93. Thereafter, CPU 91 advances the process to S15.

In S15, CPU 91 inputs the stop time ST, the stop time temperature T1, the start time temperature T2, and the time-series data DA of the rotational speed of the oil pump 52 into the map indicated by the mapping data DM.

As a result, the mapping outputs the predicted value PP of the transmission torque, which is an output variable, with the stop time ST being the stop time temperature T1, the start time temperature T2, and the time-series data DA of the rotational speed of the oil pump 52 as input variables. The transmission torque is an upper limit value of the torque that can be transmitted by the torque converter 70. As ST of stop times is longer, the predicted value PP of the transmitted torque is smaller. In the mapping, the higher the stop time temperature T1 is, the smaller the predicted value PP of the transmitted torque is. In the mapping, the higher the start time temperature T2, the higher the predicted value PP of the transmitted torque. Thereafter, CPU 91 advances the process to S16.

In S16, CPU 91 obtains a predicted value PP of the transmitted torque-the output-variable from the map. That is, CPU 91 calculates the predicted value PP of the transmitted torque based on the stop time ST, the stop time temperature T1, the start time temperature T2, and the time-series data DA of the rotational speed of the oil pump 52 using the map. Thereafter, CPU 91 advances the process to S17.

In S17, CPU 91 obtains the tilt angle TA detected by the gradient sensor 106. Thereafter, CPU 91 advances the process to S18.

In S18, CPU 91 calculates the specified torque TR based on the tilt angle TA. The specified torque TR is a lower limit of the transmission torque required to enable the vehicle VC to start. CPU 91 calculates the specified torque TR larger as the tilt angle TA decreases. Thereafter, CPU 91 advances the process to S19.

In S19, CPU 91 determines whether or not the predicted value PP of the transmitted torque is equal to or greater than a specified torque TR. When the predicted value PP of the transmitted torque is less than the specified torque TR (S19: NO), CPU 91 advances the process to S30.

In S30, CPU 91 determines that a lost drive condition of the torque converter 70 has occurred. Then, CPU 91 updates the flag stored in the storage device 93 indicating whether or not a lost drive state has occurred to the ON state. Thereafter, CPU 91 advances the process to S31.

In S31, CPU 91 performs a notification process. The notification process is a process of notifying the user of the vehicle VC of the lost drive status. Specifically, CPU 91 controls the display 30 to display images indicating the occurrence of the lost drive status. As a result, the display 30 starts displaying an image indicating the occurrence of the lost drive state. CPU 91 then returns the process to S14.

On the other hand, in S19 process, when the predicted value PP of the transmitted torque is equal to or greater than the specified torque TR (S19: YES), CPU 91 advances the process to S20. In S20, CPU 91 determines that a lost drive condition of the torque converter 70 does not occur. Then, CPU 91 updates the flag stored in the storage device 93 indicating whether or not a lost drive state has occurred to the off state. Thereafter, CPU 91 advances the process to S21.

In S21, CPU 91 suspends the notification by the notification process. Specifically, when an image indicating the occurrence of the lost drive status is displayed on the display 30, CPU 91 performs control so as to stop the display of the image. As a result, the display 30 displays an image indicating the occurrence of the lost drive state, and stops the notification by stopping the display of the image when the notification is being performed. Thereafter, CPU 91 ends the series of processes.

In this way, when CPU 91 repeats the negative determination in S19, CPU 91 repeats the processes of S14 to S19, S30 and S31. Therefore, after the oil pump 52 starts driving, CPU 91 continues the notification by the notification process while the predicted value PP of the transmitted torque is less than the specified torque TR.

When an affirmative determination is made in S19 after S31 process is performed, CPU 91 stops the notification process in S21 process. That is, CPU 91 stops the notification processing when the predicted value PP of the transmission torque becomes equal to or larger than the specified torque TR when the notification is made by the notification processing.

### Effect of this embodiment

(1) In addition to the time-series data DA of the rotational speed of the oil pump 52, the control device 90 calculates a predicted value PP of the transmitted torque based on the stop time ST. In a state in which the oil pump 52 is stopped, the oil is not supplied to the torque converter 70. Therefore, the longer the stop time ST is, the shortage of

the oil in the torque converter 70 becomes. The shortage of oil in the torque converter 70 decreases the transmission torque. When the transmission torque decreases, a lost drive state is likely to occur. The control device 90 determines whether or not a lost drive condition has occurred by using the predicted value PP of the transmission torque calculated based on the stop time ST. Accordingly, the control device 90 can improve the accuracy of determining whether or not a lost drive condition has occurred, as compared with the case of only the time-series data DA of the rotational speed of the oil pump 52.

(2) CPU 91 determines that a lost drive condition has occurred when the predicted value PP of the transmitted torque is less than the specified torque TR. After the oil pump 52 starts driving, when the predicted value PP of the transmitted torque is less than the specified torque TR, CPU 91 executes a notification process. By the notification process, the control device 90 can suppress a sense of anxiety given to the user of the vehicle VC even when the vehicle VC cannot start.

(3) CPU 91 stops the notification processing when the predicted value PP of the transmitted torque becomes equal to or larger than the specified torque TR during the notification processing. Therefore, the control device 90 can notify the user of the vehicle VC that the vehicle VC can be started at a timing at which the notification process is stopped.

(4) The stop time temperature T1 changes the time from the state in which the oil of the torque converter 70 is insufficient to the state in which the oil is insufficient. Specifically, the higher the stop time temperature T1, the more easily the oil flows to the oil pan 51 because the oil is less viscous. Therefore, the time becomes shorter as the stop time temperature T1 is higher.

The control device 90 calculates a predicted value PP of the transmission torque based on the stop time temperature T1 in addition to the stop time ST and the time-series data DA of the rotational speed of the oil pump 52. Therefore, the control device 90 can calculate the predicted value PP of the transmission torque to be calculated with higher accuracy than when the stop time temperature T1 is not used.

(5) The start time temperature T2 changes the time from the state in which the oil of the torque converter 70 is insufficient to the state in which the oil is insufficient. Specifically, the higher the start time temperature T2, the higher the viscosity of the oil, so that the oil is easily supplied from the oil pan 51 to the transmission device 40. Therefore, the time is shorter as the start time temperature T2 is higher.

The control device 90 calculates a predicted value PP of the transmitted torque based on the start time temperature T2 in addition to the stop time ST and the time-series data DA of the rotational speed of the oil pump 52. Therefore, the control device 90 can calculate the predicted value PP of the transmission torque to be calculated with higher accuracy than when the start time temperature T2 is not used.

### Example of change

The above-described embodiment can be modified as follows. The present embodiment and modifications described below may be carried out in combination within a technically consistent range.

CPU 91 may not continue the notification process performed by S31 until S21 is performed. For example, after executing the notification process, CPU 91 may display an image indicating that the display 30 is in the lost drive mode for a predetermined period of time, regardless of whether or not S21 is performed, and then terminate the display of the image.

The notification process is not limited to the example of the above-described embodiment. For example, CPU 91 may output, from the audio of the vehicle VC, a sound indicating that a lost drive condition is occurring.

CPU 91 may not execute the notification process. For example, CPU 91 may control VC of vehicles based on the determination that a lost drive condition has occurred.

CPU 91 may calculate the predicted value PP of the transmitted torque without being based on the start time temperature T2. In addition, CPU 91 may calculate the predicted value PP of the transmitted torque without being based on the stop time temperature T1. At least, CPU 91 may calculate the predicted value PP of the transmitted torque based on the stop time ST and the time-series data DA of the rotational speed of the oil pump 52.

CPU 91 may calculate the specified torque TR based on the weight of the vehicle VC. CPU 91 may calculate the specified torque TR larger as VC weighs larger. The specified torque TR may be determined in advance by testing or simulating, regardless of the tilt angle TA.

The power transmission device is not limited to the torque converter 70. The power transmission device may be a fluid coupling, i.e. a fluid coupling, without torque-increasing side effects.

The oil pump 52 is not limited to a mechanical pump, and may be an electric pump.

The method of detecting the rotational speed of the oil pump 52 is not limited to the example of the above-described embodiment. It may be detected by a sensor that detects the number of revolutions of the oil pump 52.

What is claimed is:

1. A vehicle control device that controls a vehicle comprising: a power transmission device that is provided between an engine and a transmission mechanism and transmits power from a pump impeller connected to a crankshaft of the engine to a turbine impeller connected to the transmission mechanism via oil; and
an oil pump that supplies the oil to the power transmission device, wherein
the vehicle control device
calculates a predicted value of a transmission torque transmitted to the transmission mechanism by the power transmission device based on a stop time since a time when the oil pump is stopped until a time when the oil pump starts driving for a first time after being stopped, and time-series data of a rotational speed of the oil pump from a time when the oil pump starts driving, and
determines based on the predicted value calculated whether a lost drive state of the power transmission device has occurred.

2. The vehicle control device according to claim 1, wherein the vehicle control device further
determines that the lost drive state has occurred when the predicted value is less than a specified torque that is a lower limit value of the transmission torque required to start the vehicle, and
informs a user of the vehicle that the lost drive state has occurred when the predicted value is less than the specified torque after the oil pump starts driving.

3. The vehicle control device according to claim 2, wherein the vehicle control device further stops informing the user of the vehicle that the lost drive state has occurred when the predicted value has become equal to or more than the specified torque when the user of the vehicle is informed that the lost drive state has occurred.

4. The vehicle control device according to claim 1, wherein the vehicle control device calculates the predicted value based on the stop time, the time-series data of the rotational speed of the oil pump, and a temperature of the oil at the time when the oil pump is stopped.

5. The vehicle control device according to claim 1, wherein the vehicle control device calculates the predicted value based on the stop time, the time-series data of the rotational speed of the oil pump, and a temperature of the oil at the time when the oil pump starts driving.
